(19) United States
(12) Patent Application Publication
(10) Pub. No.: US 2007/0181760 A1
(43) Pub. Date: Aug. 9, 2007

(54) Apparatus for a Shelf Support System Attached Together by a Wedge

(76) Inventor: Paul M. Segall, El Paso, TX (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/614,778

(22) Filed: Dec. 21, 2006

Related U.S. Application Data
(60) Provisional application No. 60/753,202, filed on Dec. 21, 2005.

(51) Int. Cl. A47G 29/02; E04G 3/20; E06B 7/28

(52) U.S. Cl. 248/235

(57) ABSTRACT

A self-assembly shelf support apparatus that can be easily assembled, the apparatus consisting of at least a support bracket, a leg, and a wedge. The support bracket consists of at least a sleeve which is fit over the leg and the wedge. The wedge is located between the tapered surface of the sleeve and a front region of the leg. The leg contains openings spaced vertically along the front region of the leg which receive a tab from the back surface of the wedge. Both the tapered region of the sleeve and the front of the wedge are tapered similarly and both decrease upwardly.

### FIELD

This disclosure relates generally to an apparatus for supporting a bracket on a leg, and more particularly to a wedge that supports a shelf bracket on a leg.

### BACKGROUND

Shelving systems are commonly used by consumers for storage around homes or offices and equally common are shelving systems that consumers assemble and adjust themselves. Typically, shelving systems that are assembled by the consumer consist of at a minimum a shelf support, a rod or leg, and a screw or other type of fastening system that usually requires a tool of some sort to assemble. This may make assembly difficult and time-consuming.

There are other types of self-assembly shelving systems that do not require any type of tooling but rather utilize various snap-on pieces. One such self-assembly shelf system consists of a corner piece shelf portion, a post, a collar piece that snaps around the post and corner piece shelf portion to form a split-sleeve, and a wedge piece. The snap on wedge piece has one or more detent tabs, typically two, that snap into detent steps or grooves vertically located along the post. The detent steps are placed at frequent intervals along the post such that the consumer can choose almost any potential height position for the shelf. The detent steps are typically formed every ½ inches along the post. The wedge piece wraps around the edges or apex of the post as it is snapped into place against it and is further secured in place by the wrap around collar piece. The wedge is designed to clip onto the support post with lips that wrap around the edges of the post. Additionally, the wedge piece has an opening or window in the front to allow for viewing the detent steps on the post beneath which are all identified by a reference number. The sleeve, formed by joining the collar piece and the corner piece of the shelf together, seats on the wedge and is held into place by a combination of the wedge action and the support from the detent tabs snapping into the steps. Alternatively, shelving systems of the type discussed above may only consist of three pieces, where the sleeve piece is one contiguous piece, but the wedge and post are the same and perform the same function as discussed above.

However, a drawback with these types of self-assembly shelves is that the assembly process may become difficult instead of simpler. The clip on wedge piece may make disassembly or adjustment of the shelf height difficult because the wedge must be pulled off with an adequate force to un-clip it from the post. Also, if the wedge is made out of metal, it may scratch the post each time it is snapped on and off; and if the wedge is made out of plastic, it may similarly scratch up the post or even break if too much force is applied during the assembly or disassembly process. Additionally, when assembling the shelves, placement of the wedge piece on the post may become confusing with all of the numerous detent steps or grooves available to snap the wedge into. The reference numbers that appear through the window in the wedge piece must all match the numbers of wedges on adjacent posts which may make assembly tedious instead of easier and may further become difficult if the consumer misreads the location of the number in the window thus causing the shelves to be placed incorrectly at an angle and thus misbalanced.

### SUMMARY

An apparatus is disclosed for assembling a shelf support system without the use of tools or other complicated methods using instead a simplified wedge piece that does not need to be clipped on and off the leg. The shelf assembly comprises a bracket which contains the shelf supported thereon and attached to a leg with a wedge positioned therebetween. The bracket and the leg are preferably constructed of metal with the wedge preferably constructed of plastic.

The leg extends upwardly with a perimeter having a first region that faces inwards towards the interior of the shelf and a second region facing outwards and opposite the first region. The first region is generally flat and the second region is generally curved, such that the leg forms a substantially triangular perimeter with rounded edges.

The bracket has a sleeve which at least partially surrounds the perimeter of the leg with a tapered portion adjacent to the first region of the leg. A wedge is then positioned between the two, where the wedge has a surface that decreases upwardly similar to the taper of the sleeve. The wedge contains a tab or protrusion on its back side that mates with holes or openings placed vertically along the first region of the leg. The shelf or bracket may be supported solely by the force created by the wedge action between the wedge and the bracket and leg. Prior to the addition of the bracket, the wedge may be solely supported by the tab, or may be loosely supported by the tab. Furthermore, there may be no opening or window needed on the wedge for viewing the openings on the leg because the openings are not so close together as to cause accidental misalignments by placing the wedge in an incorrect hole or opening between adjacent leg posts that would cause the shelf to be misbalanced.

### DETAILED DESCRIPTION OF THE DRAWINGS

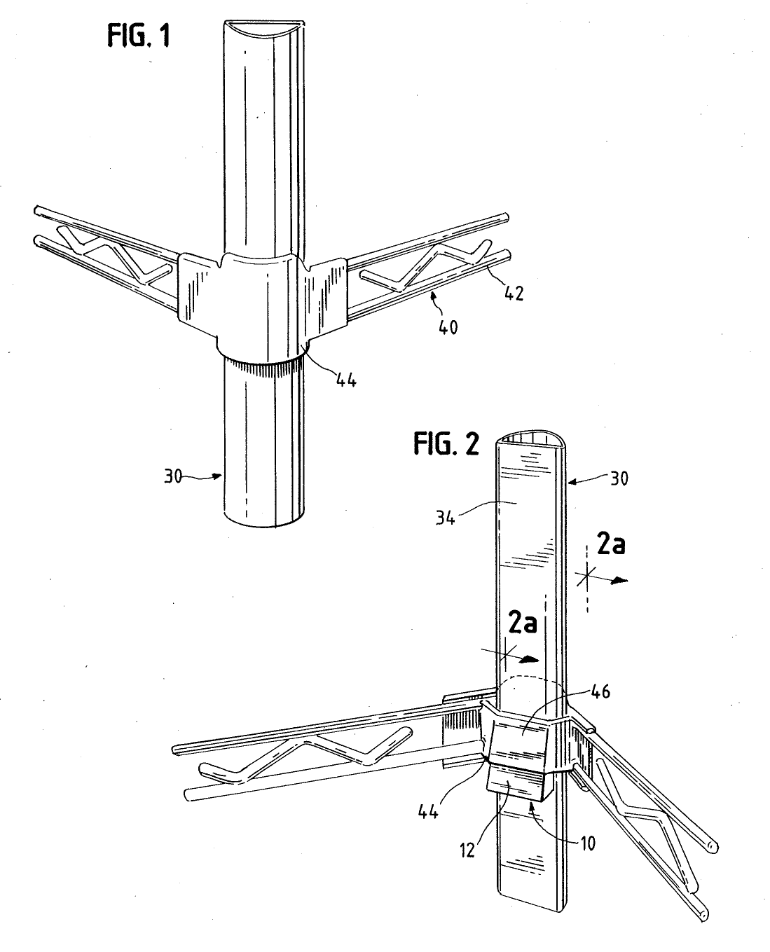

FIG. 1 is a diagrammatic exterior perspective of a shelf assembly apparatus;

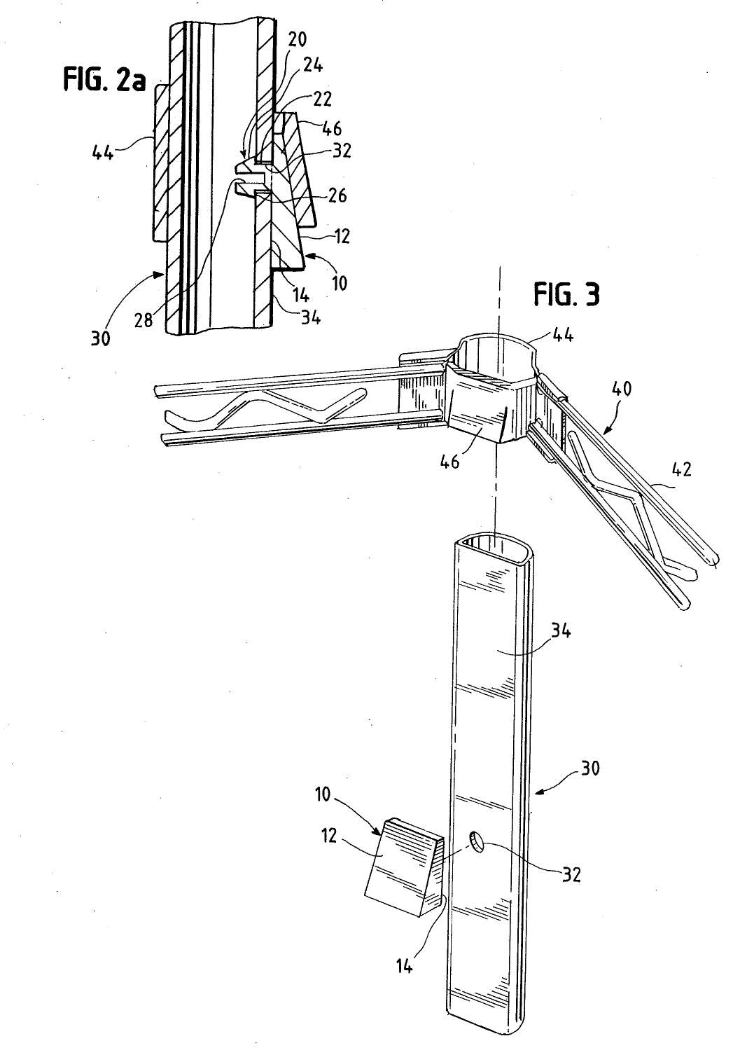

FIG. 2 is a diagrammatic interior view of the shelf assembly apparatus;

FIG. 2A is a cross-section view taken along the lines 2A-2A in FIG. 2; and

FIG. 3 is an exploded view of the shelf assembly apparatus.

### DETAILED DESCRIPTION

An apparatus is disclosed herein and illustrated in FIGS. 1-3 for a supporting bracket attached to a leg and held in place by a wedge piece, and in particular for a self-assembly shelving system. Although only a single bracket is shown and described, it will be appreciated that a plurality of such brackets with shelves may be supported on the legs and that one bracket shelf will be attached to at least three such legs. The apparatus preferably includes a wedge that fits to the leg and supports the supporting bracket by being wedged between the bracket and the leg.

The shelving system assembly consists of three main parts: the leg, the support bracket and the wedge. Only these three pieces are necessary in order to assemble the shelving system. The leg 30, as shown in FIG. 2, extends upwardly having a segment defined by a perimeter. The leg 30 has an outer perimeter portion where the interior may be hollow. The perimeter of the leg has a first region 34 that faces inwards towards the interior of the shelving system and a second region that faces outwards and is generally opposite the first region 34. The first region 34 has a substantially flat surface or a straight edge. The second region is curved or semi-circular. The leg 30 may have a substantially triangular shape with curved edges, so that there are essentially three sides to the leg 30. The substantially triangular shape gives the leg 30 more stability in the design than if it were just a circular rod or polygonal shape, and it takes up less space from the corners of the shelf that can be used for storage.

The leg 30 has a plurality of openings or holes 32 placed vertically along the first region 34 to receive a tab from the wedge, as will be explained in more detail later. The openings 32 may be spaced vertically apart at a distance of at least as great as the height of the wedge, more preferably at about 2 inches apart. The openings 32 may be centrally spaced in a single column. The bottom ends of the leg 30 in contact with a floor or support surface may contain castors or wheels for easy movement. Alternatively, the bottom ends of the leg 30 may only contain a plug which keeps the leg in a stationery position.

The support bracket 40 may consist of a continuous horizontal piece generally square or rectangular shaped with a ledge section placed on top of the brackets 40 or contiguous therewith, such that it may be used as a shelf for storage of items. Alternatively, the shape of the shelf and brackets may be triangular. The support bracket 40 comprises a sleeve that has a tapered surface 46 which faces towards the interior of the shelves and where the tapered portion is adjacent to the first region 34 of the leg 30. The sleeve also has a back portion 44 facing the second region of the leg 30 and shaped to compliment the second region of the leg 30. The tapered portion 46 conforms to the shape of the first region 34 of the leg 30 and to the shape of the wedge 10, such that the wedge 10 is able to fit between the leg 30 and the tapered portion 46 of the sleeve, which will be discussed in more detail below. The shelf may have at least three support brackets 40 attached to its periphery, and preferably four support brackets 40, where each bracket 40 contains a sleeve. A bracket 40 may have two horizontal arms 42 that extend horizontally therefrom, one arm 42 from each side of the bracket 40 having approximately a 90 degree angle between the arms 42.

The sleeve is configured to at least partially surround the perimeter of the segment of the leg, and more preferably, to completely surround it. The tapered portion 46 of the sleeve decreases upwardly, as can be better seen in FIG. 2A. As shown in FIG. 3, the sleeve of the support bracket 40 fits over the leg 30, such that the backing portion 44 fits snug along the second region of the leg 30 and is similarly curved such that it compliments the curved surface of the second region of the leg 30. The tapered portion 46 has a substantially flat surface that also compliments the flat surface of the first region 34, however with some space in between the two so that it is not completely snug and allows for placement of a wedge 10 therebetween. The sleeve slips down midway over the wedge 10 which secures the shelf to the pole via the sleeve. The shelves become even more secure as additional weight is loaded onto the shelf, further tightening the connection between the shelf and leg 30. The arms 42 of the bracket support 40 extend horizontally to the next bracket support at the opposite corner and so on until a four-sided polygon is formed. A typical leg 30 will contain at least one bracket support shelf 40, and more preferably, 2 to 3 bracket support shelves. The bracket support 40 is preferably comprised of metal.

A wedge piece 10 is provided to support the bracket support 40 relative to the leg 30. The wedge 10 has a front inclined surface 12 and a back flat surface 14. The front surface 12 of the wedge 10 is inclined such that it decreases upwardly thus matching the incline of the tapered portion 46 of the sleeve. The wedge 10 is positioned between the first region 34 of the leg 30 and the tapered portion 46 of the sleeve at the hole on the leg 30 that corresponds to the desired height of the shelf. The inclined surface of the wedge 12 fits adjacent the tapered portion 46 of the sleeve. The inclined surface of the wedge 12 and the tapered portion 46 of the sleeve cooperate to urge the wedge 10 and the backing portion 44 of the sleeve against the perimeter of the segment of the leg 30 when a downwardly force acts upon the bracket 40 and generally supports the bracket on the leg 30.

The wedge 10 has a tab or protrusion 20 centrally disposed on its back surface 14, as can be seen in FIG. 2A, which is used to position it on the leg 30. The wedge 10 is a solid piece that preferably, though not necessarily, lacks any openings or windows on its body. The wedge 10 preferably has a width selected to be substantially the same as the adjacent portion of the leg 30. That is, the wedge 10 lacks any portion that substantially wraps around a portion of the leg 30, such as side or wing clips. The tab 20 fits into one of the vertical openings 32 that is located along the first region 34 of the leg 30. The diameter of the tab 20 on the back surface 14 of the wedge 10 is slightly smaller than the diameter of the openings 32 located on the leg 30, such that the tab 20 on the wedge 10 mates with the opening 32 easily. The wedge 10 does not snap or attach to the leg 30 but rather is held in place by the force upon it from the sleeve when the sleeve fits over the wedge 10, thus holding it in place between the leg 30 and the sleeve of the support bracket 40. It is the wedge action of the sleeve pressing on the wedge 10 and the leg 30 that provides the vertical support for the shelf and support bracket 40. When the support bracket 40 is removed and the sleeve is raised up off of the wedge 10, it no longer holds the wedge 10 in place because pressure is no longer placed against it and, hence, the wedge easily falls off the leg 30 and can be removed. Thus when the sleeve is raised, the wedge 10 becomes loose and may fall off from the leg 30 and out of the openings 32, making it simple to disassemble or to make quick height adjustments. The material of construction of the wedge 10 is preferably a plastic material.

From the foregoing, it will be appreciated a shelving system having one or more legs, one or more brackets and one or more wedge pieces is provided that allows for self-assembly of the shelving system, and is used for storing items upon the shelves of the shelving system. However, the disclosure is not limited to the aspects and embodiments described hereinabove, or to any particular embodiments. Various modifications to the legs, brackets, wedge, and sleeve can result in substantially the same shelving system.

1. An assembly for supporting a bracket on a leg, the assembly comprising:
an upwardly extending leg having a segment with a perimeter, the perimeter having a substantially flat first region and a second region generally opposite the first region and where the first region contains openings vertically spaced along the leg;
a bracket having a sleeve configured to at least partially surround the perimeter of the segment of the leg, the sleeve having a tapered portion adjacent the first region of the leg and a backing portion facing the second region of the leg, the tapered portion decreasing upwardly; and
a wedge positioned between the first region of the leg and the tapered portion of the sleeve where the wedge has a tab on a back surface which mates with an opening on the first region of the leg to support the wedge on the leg, the wedge having an inclined surface decreasing upwardly adjacent the tapered portion of the sleeve, the inclined surface of the wedge and the tapered portion of the sleeve cooperating to urge the wedge and the backing portion of the sleeve against the perimeter of the segment of the leg when downwardly force is applied to the bracket to generally support the bracket on the leg.

2. An assembly for supporting a bracket on a leg in accordance with claim 1, wherein the wedge has a width substantially the same as the first region of the leg.

3. An assembly for supporting a bracket on a leg in accordance with claim 2, wherein the second region of the leg is a substantially curved vertical region.

4. An assembly for supporting a bracket on a leg in accordance with claim 2, wherein the leg is hollow.

5. An assembly for supporting a bracket on a leg in accordance with claim 2, wherein the bracket has arms extending in a coplanar direction therefrom to support a shelf.

6. An assembly for supporting a bracket on a leg in accordance with claim 2, wherein the openings along the first region of the leg are centrally spaced in a single column.

7. An assembly for supporting a bracket on a leg in accordance with claim 6, wherein the openings are vertically spaced at least about 2 inches apart.

8. An assembly for supporting a bracket on a leg in accordance with claim 2, wherein the back surface of the wedge is a straight vertical region.

9. An assembly for supporting a bracket on a leg in accordance with claim 2, wherein the perimeter of the leg is substantially triangular shaped with rounded edges.

10. An assembly for supporting a bracket on a leg in accordance with claim 2, wherein the sleeve of the bracket completely surrounds the perimeter of the segment of the leg.

11. A self-assembly shelving system comprising:
one or more upwardly extending legs each having a segment with a perimeter, the perimeter having a first region and a second region generally opposite the first region and where the first region contains a plurality of openings vertically spaced along the one or more legs;
one or more brackets each having a sleeve configured to at least partially surround the perimeter of the segment of the one or more legs, the sleeve having a tapered portion adjacent the first region of the leg and a backing portion facing the second region of the leg, the tapered portion decreasing upwardly; and
a wedge positioned between the first region of the one or more legs and the tapered portion of the sleeve where the wedge has a tab on a back surface which mates with an opening on the first region of the leg to solely support the wedge on the leg when the bracket is not thereagainst, the wedge having an inclined surface decreasing upwardly adjacent the tapered portion of the sleeve, the inclined surface of the wedge and the tapered portion of the sleeve cooperating to urge the wedge and the backing portion of the sleeve against the perimeter of the segment of the leg when downwardly force is applied to the bracket to generally support the bracket on the leg.

12. A self-assembly shelving system in accordance with claim 11, wherein the sleeve of each of the at least three brackets completely surrounds one of the at least three legs and the shelf is perpendicular to the leg.
